(19) United States
(12) Patent Application Publication
(10) Pub. No.: US 2026/0202026 A1
(43) Pub. Date: Jul. 16, 2026

(54) HYBRID SOLAR-ELECTRIC LIGHTING SYSTEM

(71) Applicant: Claudio Fernandez, Corona, NY (US)

(72) Inventor: Claudio Fernandez, Corona, NY (US)

(21) Appl. No.: 19/444,530

(22) Filed: Jan. 9, 2026

Related U.S. Application Data
(60) Provisional application No. 63/744,971, filed on Jan. 14, 2025.

(51) Int. Cl. F21S 19/00; F21S 9/03; F21S 11/00; F21V 3/02; F21V 15/015; F21V 17/10; F21V 17/12; F21V 23/02; F21V 23/04; F21Y 103/33; F21Y 113/20; F21Y 115/10

(52) U.S. Cl. CPC F21S 19/005; F21S 9/035; F21S 9/037; F21S 11/007; F21V 3/02; F21V 15/015; F21V 17/101; F21V 17/12; F21V 23/023; F21V 23/0464; F21Y 2103/33; F21Y 2113/20; F21Y 2115/10

(57) ABSTRACT

Disclosed examples may provide a hybrid lighting system that utilizes both solar power and natural light to provide lighting to an internal space of a facility (e.g., a structure with one or more walls defining the internal space). The hybrid lighting system may be installed within or on a roof or ceiling to illuminate the internal space beneath the roof or ceiling. The hybrid lighting system may have dual functionality. For example, the hybrid lighting system may channel and/or diffuse natural light (e.g., sunlight, moonlight, etc.) into a facility using a cylinder comprised of a transparent material conducive to diffusing natural light to create a light source. The hybrid lighting system, in addition to channeling natural light, may include a solar cell that generates electricity from natural light (e.g., such as light during daytime hours).

### CROSS-REFERENCE TO RELATED APPLICATIONS

The present patent application claims the benefit of priority to U.S. Provisional Patent Application No. 63/744,971 filed Jan. 14, 2025, which is incorporated herein by reference in its entirety for all purposes.

### BACKGROUND

Internal lighting systems are essential for providing adequate illumination within enclosed spaces, particularly in areas with limited access to natural light. Traditional lighting solutions, such as incandescent, fluorescent, or LED fixtures, rely heavily on electrical power, contributing to significant energy consumption and operational costs. While advancements in energy-efficient lighting technologies have addressed some concerns, there remains a growing interest in leveraging natural light as a sustainable and cost-effective alternative.

### BRIEF SUMMARY

In some aspects, a hybrid lighting system may include a solar cell and cylinder. The cylinder may comprise a transparent material configured to diffuse natural light to light a facility. The cylinder may include a protective cap removably connected to a first end of the cylinder. The protective cap may be configured to insulate the internal cylinder from an external environment and comprise a transparent material configured to allow natural light to pass from the external environment to the cylinder. The cylinder may also include a domed cap removably connected to a second end of the cylinder, one or more power sources electrically coupled to the solar cell, and one or more light components electrically coupled to the one or more power sources. The one or more light components may be configured to provide light to the facility based on a signal. one or more light component

In another aspect, a hybrid lighting system may include a cylinder comprising a transparent material configured to diffuse natural light to light a facility. The cylinder may also include one or more light components electrically coupled to one or more power sources, where the one or more light components are configured to provide light to the facility based on a signal. The hybrid lighting system may also include a protective cap connected to an end of the cylinder, where the protective cap is configured to insulate the cylinder from an external environment. The protective cap may comprise a transparent material configured to allow natural light to pass from the external environment to the cylinder.

In summarizing this device, certain aspects and advantages have been described. The new device or method may be made or carried out to achieve or optimize one set of advantages without necessarily achieving other advantages.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of the hybrid solar-electric lighting system according to some aspects of the present disclosure.

FIG. 2A illustrates a cross-section view of an example attachment mechanism between a cylinder, a solar cell, and a protective cap component of the hybrid solar-electric lighting system according to some aspects of the present disclosure.

FIG. 2B illustrates a cross-section view of an example attachment mechanism between the cylinder, the solar cell, and the protective cap component of the hybrid solar-electric lighting system according to some aspects of the present disclosure.

FIG. 3A illustrates a perspective view of the cylinder component of a hybrid solar-electric lighting system according to some aspects of the present disclosure.

FIG. 3B illustrates a cross-section view of an example attachment mechanism between the cylinder, the solar cell, and the protective cap component of the hybrid solar-electric lighting system according to some aspects of the present disclosure.

FIG. 4 illustrates a perspective view of the hybrid solar-electric lighting system according to some aspects of the present disclosure.

FIG. 5 illustrates a perspective view of an expanded hybrid solar-electric lighting system with power sources and light sources according to some aspects of the present disclosure.

FIG. 6 illustrates a view of the expanded hybrid solar-electric lighting system with power sources and light sources according to some aspects of the present disclosure.

FIG. 7 illustrates a view of the cylinder of the hybrid solar-electric lighting system according to some aspects of the present disclosure.

### DETAILED DESCRIPTION

Unless defined otherwise, all technical and scientific terms used in this disclosure have the same meanings as commonly understood by one skilled in the art to which the disclosed examples pertains. Singular forms (e.g., a, an, the, etc.) include plural referents unless the context indicates otherwise. Thus, a reference to “fluid” refers to one or more fluids, such as two or more fluids, three or more fluids, etc. When an aspect is said to include a list of components, the list is representative. If the component choice is specifically limited to the list, the disclosure will say so. Moreover, listing components acknowledges that exemplars exist for each component and any combination of the components, including combinations that exclude any one or any combination of the listed components. For example, “component A is chosen from A, B, or C” discloses exemplars with A, B, C, AB, AC, BC, and ABC. It also discloses AB but not C, AC but not B, and BC but not A, as exemplars, for example. Combinations that one of ordinary skill in the art knows to be incompatible with each other or with the components'function in this device are excluded from this device, in some exemplars.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be not intervening elements or layers present. Other words used to describe the relationship between elements should be interpreted in a like fashion (e.g., “between” vs. “directly between,” “adjacent” vs. “directly adjacent,” etc.).

Although the terms first, second, third, etc. may described various elements, components, regions, layers, or sections, these elements, components, regions, layers, or sections should not be limited by these terms. These terms may only distinguish one element, component, region, layer, or section from another region, layer, or section. Terms such as “first,” “second,” and other numerical terms do not imply a sequence or order unless indicated by the context. Thus, a first element, component, region, layer, or section discussed below could be termed a second element, component, region, layer, or section without departing from this disclosure.

Spatially relative terms, such as “inner,” “outer,” “beneath,” “below,” “lower,” “above,” “upper,” and the like, may be used for ease of description to describe one element or feature's relationship to another element or feature as illustrated in the figures. Spatially relative terms may be intended to encompass different orientations of this device in use or operation and the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted accordingly.

The description of the exemplars has been provided for purposes of illustration and description. It is not intended to be exhaustive or to limit the invention. Individual elements or features of a particular exemplar are generally not limited to that exemplar but, where applicable, or interchangeable and can be used in a selected exemplar, even if not explicitly shown or described. The same may also be varied in many ways. Such variations are not a departure from the invention, and all such modifications are included within the invention's scope.

Disclosed examples may provide a hybrid lighting system that utilizes both solar power and natural light to provide lighting to an internal space of a facility (e.g., a structure with one or more walls defining the internal space). The hybrid lighting system may be installed within or on a roof or ceiling to illuminate the internal space beneath the roof or ceiling. The hybrid lighting system may have dual functionality. For example, the hybrid lighting system may channel and/or diffuse natural light (e.g., sunlight, moonlight, etc.) into a facility using a cylinder comprised of a transparent material conducive to diffusing natural light to create a light source. The hybrid lighting system, in addition to channeling natural light, may include a solar cell that generates electricity from natural light (e.g., such as light during daytime hours). The electricity generated by the solar cell may be stored in one or more power sources housed within parallel cavities of the cylinder. The one or more power sources may provide power to one or more light components, which may be used to illuminate the internal space during time intervals when natural light cannot. Although the hybrid lighting system may have dual functionality, in some examples, only one functionality may be used at a time. For example, during daylight hours, the one or more light components may not be used to illuminate the internal space because the natural light diffused through the hybrid lighting system is sufficient to illuminate the area. However, in other examples, the one or more light components may be used in lieu of natural light diffused through the hybrid lighting system (e.g., during nighttime hours or when there is limited natural light, such as during a thunderstorm). However, there are examples where the hybrid lighting system may provide a light source using both functionalities (e.g., natural light diffused through the hybrid lighting system and the light components).

The one or more light components may be turned on by a signal received from a control device of the hybrid lighting system. The signal may be initiated by one or more components, such as, but not limited to, a light sensor, a manual switch, a timer, any combination thereof, or the like. In some examples, switching between the two functionalities may be done automatically, such as by a light sensor associated with the hybrid lighting system. For example, if the light sensor detects a threshold amount of natural light, the one or more light components may be turned off. If the detected light falls below the threshold amount of natural light, the one or more light components may receive the signal and be automatically turned on. In some examples, switching between the two functionalities may be performed by a timer that operates the hybrid lighting system according to a predetermined schedule. For example, the one or more light components may turn on between the hours of 5:00 pm and 7:30 am. In some examples, the hybrid lighting system may be associated with a manual override switch, which may turn on the one or more light components, regardless of the predetermined schedule and/or the amount of natural light detected by the light sensor. In some examples, the signal may be initiated by two or more possible components associated with the hybrid lighting system. For example, a light sensor and a manual switch may be configured to initiate the signal to turn on the one or more light components of the hybrid light system.

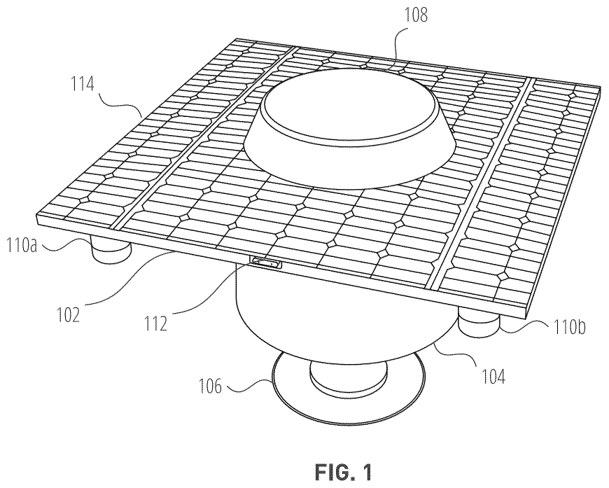

FIG. 1 illustrates a perspective view of the hybrid solar-electric lighting system according to some aspects of the present disclosure. The hybrid lighting system may be comprised of multiple components, including at least substrate 102, solar cell 114, cylinder 104, domed cap 106, and protective cap 108. In some examples, these components may be distinct components affixed together through one or more attachment mechanisms. In some other examples, one or more of the components of the hybrid lighting system may be monolithic (e.g., a singular component) of the hybrid lighting system. For example, protective cap 108 and cylinder 104 may be a single monolithic component of the hybrid lighting system or may be two distinct components affixed to one another via a fixation mechanism (e.g., screws, dowels, rivets, threads of the protective cap engaging with corresponding threads of cylinder 104, one or more adhesives, combinations thereof, and/or the like).

In some examples, multiple instances of the hybrid lighting system may be combined to create a lighting system array comprised of multiple hybrid lighting systems. The multiple instances of the hybrid lighting systems may be electrically coupled via electrical port 112. The electrical coupling may enable the wholistic lighting system to be controlled by a control panel, controller, module, system, computer, switch, etc. In some examples, a first hybrid lighting system may transfer power to a second hybrid lighting system. For example, a first hybrid lighting system may supply power to a second hybrid lighting system to charge a power source of the second hybrid lighting system or to provide power to one or more light components associated with the second hybrid lighting system, etc. The second hybrid lighting system may send a signal to the other hybrid lighting systems of the lighting system array (e.g., the first hybrid lighting system) requesting power when a power supply drops below a threshold level. Alternatively, or additionally, a control device (e.g., the control panel, controller, module, system, computer, switch, etc.) may monitor the power generated by each hybrid lighting system and direct transfer power generated by solar cell 114 of any hybrid lighting system to any other hybrid lighting system in the lighting system array.

The hybrid lighting system shown in FIG. 1 may be placed on a roof and/or ceiling of a facility. The facility may include be a structure comprising a roof and one or more walls separating an external environment from an internal space. In some instances, solar cell 114 may be positioned on top of substrate 102 of hybrid lighting system facing the external environment to enable capturing natural light (e.g., sunlight, etc.) of the external environment. Substrate 102 may be comprised of a rigid material configured to support solar cell 114. In some instances, substrate 102 may comprise a same or similar material as cylinder 104, protective cap 108, or the like. Solar cell 114 may be affixed to substrate 102 using one or more fixators such as, but not limited to, nails, dowels, rivets, screws, adhesives, combinations thereof, and/or the like. In some instances, solar cell 114 may positioned separate from hybrid lighting system. In those instances, the hybrid lighting system may include cylinder 104, protective cap 108, and domed cap 106, with substrate 102 being optionally included. Solar cell 114 may be connected to an electrical port of protective cap 108 or cylinder 104 via a wire to provide electrical power to the hybrid lighting system. Solar cell 114 may be affixed to the roof of the facility using any of the aforementioned fixators.

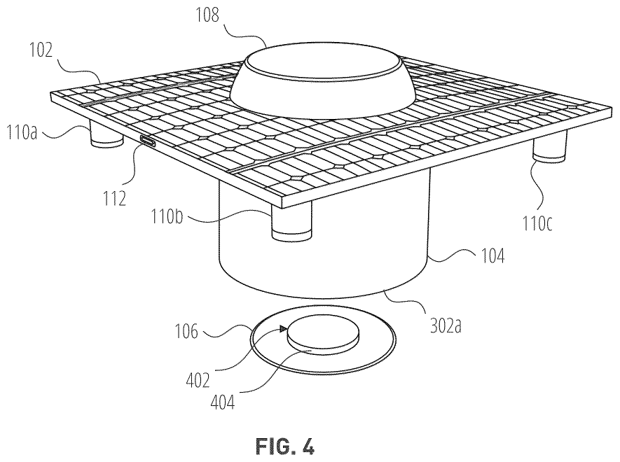

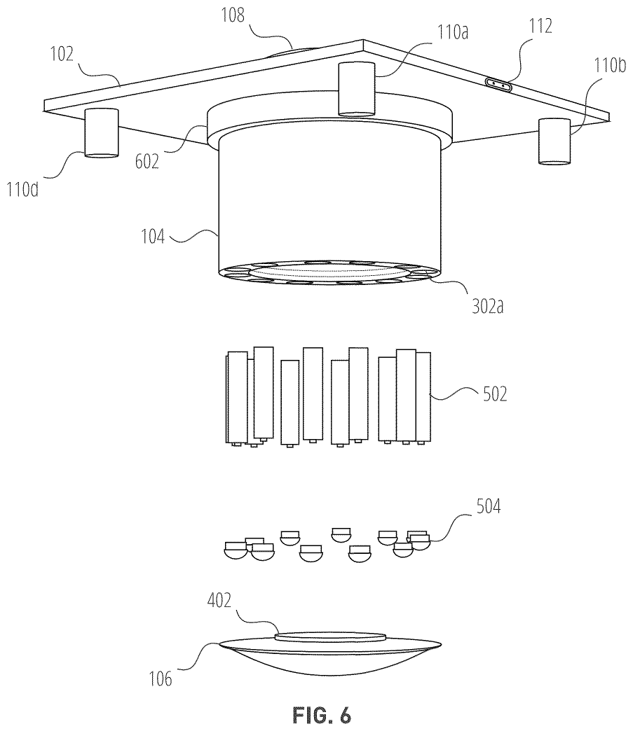

In some examples, substrate 102 may include leg 110a, leg 110b, leg 110c (e.g., pictured in FIG. 4), and leg 110d (e.g., pictured in FIG. 6) (collectively referred to as legs 110). Legs 110 may extend from various locations of substrate 102, including the corners, as pictured in FIG. 1. Legs 110 may be distinct component from substrate 102 and may be physically affixed to substrate 102 (e.g., using any of the aforementioned fixators, etc.). In some examples, legs 110 and substrate 102 may be a single monolithic component of hybrid lighting system. In some examples, the hybrid lighting system may be affixed to the roof of the facility via legs 110 using any of the aforementioned fixators substrate 102. For example, one or more screws may be used to affix one or more of legs 110 to the roof, thereby affixing the hybrid lighting system to the roof. In some examples, the length of legs 110 may be individually adjustable. For example, legs 110 may include a “foot” portion at a first end of legs 110 that contact the roof of the facility. The “foot” portion may be adjusted to increase or decrease the longitudinal length of legs 110. The “foot” portion may be actuated by rotating the “foot” portion relative to the legs 110 in one direction to increase the longitudinal length of legs 110 and rotating the “foot” portion relative to legs 110 in an opposite direction to decrease the longitudinal length of legs 110. Alternatively, the “foot” portion may be a telescope component pressure fit into a cavity of legs 110 that can be extended to increase the longitudinal length of legs 110 and retracted to reduce the longitudinal length of legs 110.). For example, leg 110a may be adjusted to be a different length than leg 110b to accommodate an uneven roof surface or a sloping roof. In some other examples, legs 110 may protect substrate 102 from water damage by allowing water to flow under substrate 102, therefore reducing potential water damage that could occur from allowing the water to flow over substrate 102 or collect proximate to substrate 102.

Protective cap 108, cylinder 104, and domed cap 106 may be manufactured out of a material channeling and/or diffusing natural light into the internal space. The material may be transparent (allowing light to pass through without distortion), translucent (allowing light to pass through with some scattering and blurring), or any other material with appropriate characteristics for channeling and/or diffusing natural light into an enclosed area. For example, the material may be selected to include a particular light transmittance (a quantification for an amount of light passing through a material), haze (measures the degree of light scattering through a material), optical density (quantifies the attenuation of light through a material), and/or refractive index (quantifies how light bends as it passes through a material) based on the particular application of the hybrid lighting system. For example, protective cap 108, cylinder 104, and domed cap 106 may be manufactured out of glass, acrylic, polycarbonate, crystal, any combination thereof, or the like. In a lighting system array implementation, the material may be the same for each hybrid lighting system or may be different based on the particular physical location of each hybrid lighting system within the lighting system array.

Protective cap 108 may attach to cylinder 104 and may protect the internal space from the external environment. For example, protective cap 108 may allow for natural light to pass through to the internal space while preventing rain, snow, wind, insects, animals, debris, etc. from entering the internal space. In addition, protective cap 108 may insulate the internal space from temperature variations between the internal space and the external environment. Protective cap 108 may be manufactured in a dome shape, preventing precipitation and debris from gathering on top of protective cap 108. As mentioned above, protective cap 108 may be removably coupled to cylinder 104 using a physical attachment mechanism such as threads (allowing for threads of protective cap 108 to engage corresponding threads of cylinder 104, etc.) and/or any of the aforementioned fixators. Protective cap 108 may include a sealant mechanism to create an air-tight seal or water-tight seal between protective cap 108 and cylinder 104. The sealant mechanism may include, but is not limited to, adhesives, resins, O-rings, gasket, and/or the like. In some examples, may be manufactured in combination with cylinder 104 to generate a monolithic component.

Cylinder 104 may be positioned within an opening of substrate 102. Cylinder 104 may be hollow with a center cavity. The walls of cylinder 104 (e.g., the longitudinal length of cylinder 104 separating the center cavity from the external environment) may have thickness selected to accommodate one or more parallel cavities positioned along the longitudinal length of cylinder 104. One or more power sources and/or light components may be positioned within one or more of the parallel cavities. The power sources may be electrically coupled to solar cell 114, such that solar cell 114 may provide power to the power sources. The power sources may include a battery for storing power received from solar cell 114 and a control circuit for selectively actuating the light components.

The power sources may be associated with respective light components. The light components may be, but are not limited to, light-emitting diodes (LEDs), halogen capsules, microplasma bulbs, any combination thereof, or the like. The power sources and the respective light sources may be stacked along the longitudinal length of a parallel cavity. For example, the light components may be positioned at a first end of cylinder 104 that is opposite substrate 102, which would be facing towards the internal space of the facility and the power source may be positioned proximate to the light components closer towards a second end of cylinder 104 opposite the first end.

The hybrid lighting system may include at least three modes: channeling and/or diffusing natural light from the external environment to provide a light source to the internal space (hereinafter referred to as “off” mode), utilizing the light sources to provide a light source to the internal space (hereinafter referred to as “on” mode), or generating a light source using both channeling and/or diffusing natural light and the light components (hereinafter referred to as hybrid mode). If the hybrid lighting system is channeling and/or diffusing natural light, the individual power sources may not be powering the respective light components, and the respective light components may be turned off (e.g., not providing light). While in “off” mode, natural light may enter the hybrid lighting system through the protective cap. The light may be channeled through the hybrid lighting system to a location within the internal space. Alternatively, or additionally, the light may be diffused by the material of at least cylinder 104, creating a light source. The channeled and/or diffused light may illuminate the internal space, eliminating the present need for artificial light sources. In “off” mode, solar cell 114 may may convert some natural light into electricity, which may be passed to batteries of the power sources. In some other examples, the individual power sources may not be powered by solar cell 114, and the electricity generated by solar cell 114 may be transmitted elsewhere (e.g., another resource that requires electricity, batteries, a power grid, any combination thereof, or the like). In those examples, the individual power sources may include non-rechargeable batteries that may be replaced periodically. In some examples, the hybrid lighting system may include a method of reducing the light that enters the internal area while the hybrid lighting system is in “off” mode. For example, protective cap 108 and/or cylinder 104 may include an electronic and/or mechanical shutter system configured to reduce the natural light that may enter the internal area from the hybrid lighting system. In some examples, the shutter system may act as a dimmer, and the light may be reduced by some percentage between 0 and 1 (e.g., 25%, 50%, etc.).

In “on” mode, the individual power sources may provide power to the respective light components, which may illuminate the internal space. The “on” mode may be initiated based on a light sensor (e.g., where the light sensor determines that there is insufficient natural light, powering on the light sources), a timer (e.g., powering on the light sources between time intervals with insufficient natural light such as between the hours of 7:00 pm and 7:00 am), a manual switch (e.g., a switch, either electronically or physically, may be flipped to power on the light sources), any combination thereof, or the like.

In some examples, channeling and/or diffusing natural light and utilizing the light sources may occur simultaneously in hybrid mode. For example, the light sensor may be associated with one or more thresholds that indicate a level of natural light (e.g., a scale from 0 to 10, where “0 ” indicates complete darkness, such as nighttime with a new moon, while “10” indicates a maximum amount of daylight, such as a sunny day with no cloud coverage, or the like). In order to maintain a predetermined amount of light within the internal space, the light sources may need to be utilized in conjunction with channeling and/or diffusing natural light. Therefore, the one or more thresholds may be associated with an amount of light to be provided by the light components to provide the predetermined amount of light to the internal space (e.g., the predetermined amount of light less the amount of natural light, etc.). For example, if the hybrid lighting system includes eight light sources, in some examples, only four may be used based on a measurement from the light sensor. The four light sources may, in combination with the available natural light, may provide the acceptable amount of light within the internal space. Alternatively, the hybrid light system may power on the eight light components at a percentage of maximum intensity by modulating the amount of power provided by one or more of the light components where the percentage is determined by the threshold.

Domed cap 106 may be affixed to cylinder 104. Domed cap 106 may be physically affixed to cylinder 104 using a threaded interface, and/or any of the aforementioned fixators. Alternatively, domed cap 106 and cylinder may be manufactured as a monolithic component (along with any other components pictured in FIG. 1). In some examples, domed cap 106 may have a convex surface, allowing natural light to be directed to particular location within the internal space, focused onto a particular location within the internal space, unfocused to diffuse light in the internal space, etc. In some examples, domed cap 106 may be manufactured from prismatic and/or frosted materials, which may ensure even illumination throughout the enclosure.

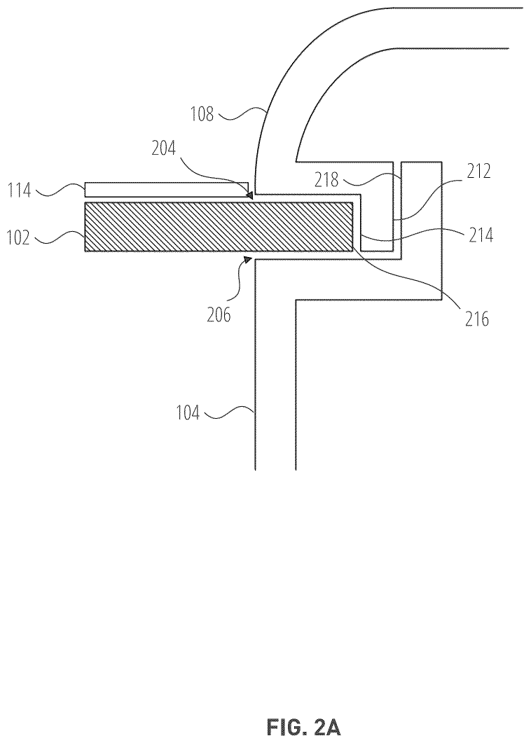

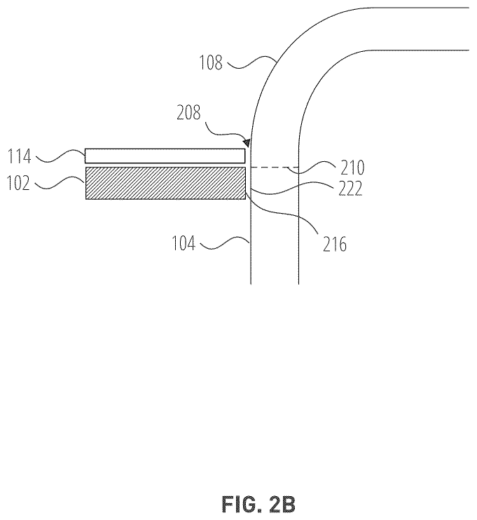

FIG. 2A illustrates a cross-section view of an example attachment mechanism between a cylinder, a solar cell, and a protective cap component of the hybrid solar-electric lighting system according to some aspects of the present disclosure. Substrate 102 may be a substantially planar surface with a circular opening with a diameter equal to or larger than the diameter of cylinder 104 and less than the diameter of protective cap 108.

In some instances, a portion of protective cap 108 may be positioned within the circular opening. In some instance, protective cap 108 may be pressure fit to substrate 102 via an exterior surface 214 of the portion of the protective cap 108 engaging surface 216 of the circular opening. Exterior surface 214 and/or surface 216 may include a sealing mechanism such as an O-ring or gasket, etc. to create an air-tight and/or water-tight seal between the exterior environment and the internal space of a facility. In other instances, the exterior surface 214 may include threads that may engage threads along the surface 216 of the circular opening. In still yet other instances, substrate 102 and protective cap 108 may be a monolithic component. In still yet other instances, substrate 102 and cylinder 104 may be a monolithic component. In still yet other instances, substrate 102, cylinder 104, and protective cap 108 may be a monolithic component.

In some examples, cylinder 104 and protective cap 108 may be affixed to substrate 102 using an interface between interior surface 212 of protective cap 108 and an exterior surface 218 of cylinder 104. Protective cap 108 may be of a diameter that overhangs the central opening of substrate 102, but may include a protrusion with threads that fits within the central opening. Cylinder 104 may also be of a diameter that is larger than the central opening but may also include a protrusion with threads that fits within the central opening. In some examples, protective cap 108 may be pressure fit to cylinder 104 via interior surface 212 engaging exterior surface 218 of cylinder 104. Interior surface 212 and/or exterior surface 218 may include a sealing mechanism such as an O-ring or gasket, etc. to create an air-tight and/or water-tight seal. In other instances, exterior surface 218 may include threads that may engage threads along interior surface 212 of protective cap 108.

In some examples, the region between protective cap 108 and substrate 102 may include seal 204, which may be a rubber gasket, a protective seal, adhesive, an O-ring, any combination thereof, or the like. Seal 204 may protect the hybrid lighting system from external elements, such as precipitation, wind, and debris. The region between cylinder 104 and substrate 102 may include seal 206, which may be a rubber gasket, a protective seal, adhesive, an O-ring, any combination thereof, or the like. Similar to seal 204, seal 206 may also be intended to protect the hybrid lighting system from external elements.

FIG. 2B illustrates a cross-section view of an example attachment mechanism between the cylinder, the solar cell, and the protective cap component of the hybrid solar-electric lighting system according to some aspects of the present disclosure. In this example, protective cap 108 and cylinder 104 may have a similar or same diameter. Protective cap 108 and cylinder 104 may be a monolithic component. Alternatively, in this example, protective cap 108 and cylinder 104 may be affixed (e.g., affixed with adhesive or another method at point 210). In some instance, protective cap 108 and cylinder 104 may be pressure fit to substrate 102 via exterior surface 222 engaging interior surface 216 of the circular opening. A diameter of protective cap 108 and cylinder 104 may be slightly less than a diameter of the central opening of substrate 102, allowing protective cap 108 and cylinder 104 to fit within the circular opening but sit flush against substrate 102. In some examples, protective cap 108 and cylinder 104 may be affixed to substrate 102 with an adhesive at interface 208. The adhesive may operate to affix protective cap 108 and cylinder 104 to substrate 102, but may also operate to protect the hybrid lighting system from external elements, such as precipitation, wind, and debris. In some examples, in addition to or in lieu of the adhesive, protective cap 108 and cylinder 104 may be affixed to substrate 102 using another method, such as screws, dowels, or nails. Interior surface 216 may include a sealing mechanism such as an O-ring or gasket, etc. to create an air-tight and/or water-tight seal between the exterior environment and the internal space of a facility. In other instances, the interior surface 216 may include threads that may engage threads along the exterior surface 222 of the circular opening.

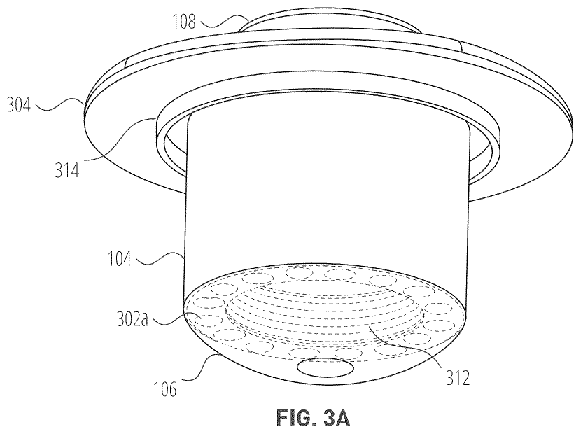

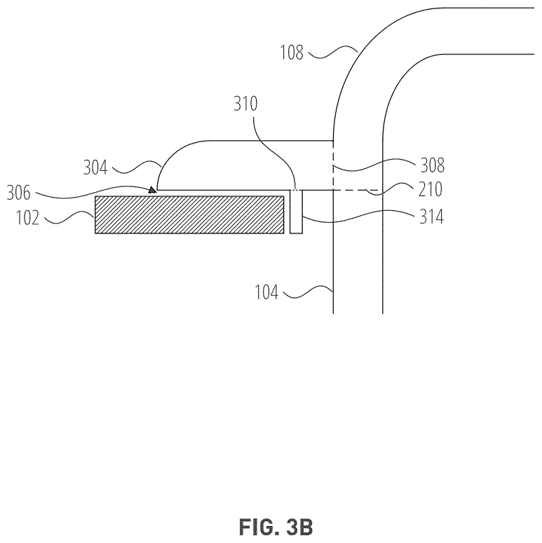

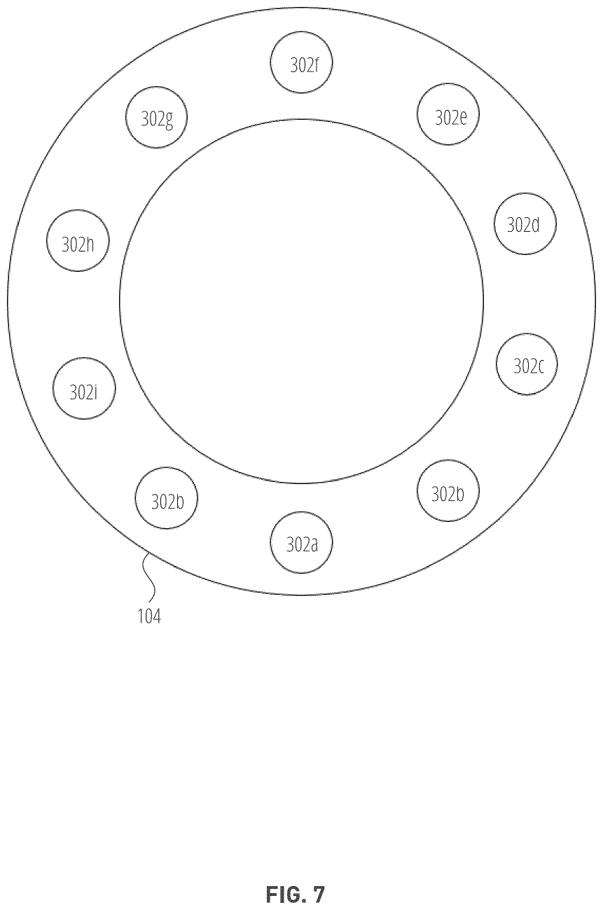

FIG. 3A illustrates a perspective view of a cylinder component of a hybrid solar-electric lighting system according to some aspects of the present disclosure. In some examples, cylinder 104 may include a first end and a second end. The first end may be attached to protective cap 108 and the second end may be attached to domed cap 106. The first end may be associated with a top end of the hybrid lighting system, while the second end may be associated with a bottom end of the hybrid lighting system. The top end may be directed towards the external environment, while the bottom end may be directed towards the internal space. Cylinder 104 may include parallel cavity 302a, parallel cavity 302b (e.g., as described in FIG. 7), parallel cavity 302c (e.g., as described in FIG. 7), parallel cavity 302d (e.g., as described in FIG. 7), parallel cavity 302e (e.g., as described in FIG. 7), parallel cavity 302f (e.g., as described in FIG. 7), parallel cavity 302g (e.g., as described in FIG. 7), parallel cavity 302h (e.g., as described in FIG. 7), parallel cavity 302i (e.g., as described in FIG. 7), and parallel cavity 302j (e.g., as described in FIG. 7) (collectively referred to as parallel cavity 302). Parallel cavity 302 should not be construed as limiting. For example, there may be a larger number of parallel cavities associated with cylinder 104 than what is shown in FIG. 1-FIG. 7. In some other examples, there may be a smaller number of parallel cavities associated with cylinder 104 than what is shown in FIG. 1-FIG. 7. One or more power sources and one or more respective light components may be positioned within parallel cavity 302. Parallel cavity 302 may be covered by domed cap 106, which may be removably affixed to cylinder 104 via threading interface 312. Threading interface 312 may include threading on the interior surface of cylinder 104 and threading on an exterior surface of a protrusion of domed cap 106. The protrusion of domed cap 106 may have a diameter slightly smaller than the inner diameter of cylinder 104, which may enable the threading of the protrusion and the threading of the interior surface of the cylinder 104 to attach.

In some examples, an extension of protective cap 108 (shown in FIG. 3A as attachment mechanism 304) may protrude beyond the circular opening of substrate 102 (e.g., a diameter associated with the central opening of substrate 102 may be less than a diameter associated with attachment mechanism 304), allowing protective cap 108 to rest on an upper surface of substrate 102 (e.g., the surface on which solar cell 114 may be positioned as shown in FIG. 2A) and cylinder 104 to be affixed directly to protective cap 108. Attachment mechanism 304 may also include extension 314 that may extend perpendicular from attachment mechanism 304 towards a lower surface of substrate 102 (e.g., an opposing surface facing the internal space of the facility and opposing the upper surface). The length of extension 314 may be approximately the width of substrate 102 (as shown). Alternatively, the length of extension 314 may be any length that does not extend beyond the bottom end of cylinder 104. Extension 314 may protect cylinder 104 from damage due to the external environment (e.g., high wind speeds, earthquakes, etc.) by providing a barrier between substrate 102 and cylinder 104. Extension 314 may also provide a stronger and more secure attachment between substrate 102 and cylinder 104. Extension 314 may be larger in diameter than cylinder 104 to create a gap between the surface of cylinder 104 facing extension 314 (hereinafter referred to as the exterior surface of cylinder 104) and a surface of extension 314 facing cylinder 104 (hereinafter referred to as the interior surface of extension 314). In some examples, the diameter of extension 314 may be slightly larger than the diameter of cylinder, such that the interior surface of extension 314 may come in contact with and/or sit flush with the exterior surface of cylinder 104. In some examples, attachment mechanism 304, extension 314, protective cap 108, and cylinder 104, or any combination thereof, may be manufactured as a monolithic component. In some other examples, attachment mechanism 304, extension 314, protective cap 108, and cylinder 104, or any combination thereof, may be affixed to each other. For example, protective cap 108 and attachment mechanism 304 may be manufactured as a monolithic component and may be affixed to cylinder 104.

FIG. 3B illustrates a cross-section view of an example attachment mechanism between the cylinder, the solar cell, and the protective cap component of the hybrid solar-electric lighting system according to some aspects of the present disclosure. Attachment mechanism 304 may rest on top of substrate 102 and may, with the assistance of gravity, hold protective cap 108 and cylinder 104 within the circular opening of substrate 102. In some examples, interface 306 may include a sealing mechanism which may be a rubber gasket, a protective seal, adhesive, an O-ring, any combination thereof, or the like, to create an air-tight and/or water-tight seal between the exterior environment and the internal space of the facility.

As mentioned above, attachment mechanism 304, extension 314, protective cap 108, and cylinder 104, or any combination thereof, may be manufactured as a monolithic component. For example, protective cap 108, extension 314, and attachment mechanism 304 may be manufactured as a monolithic component (e.g., at point 308 and point 310), and may be affixed to cylinder 104.

FIG. 4 illustrates a perspective view of the hybrid solar-electric lighting system according to some aspects of the present disclosure. In some examples, a portion of domed cap 106 may be positioned within the circular opening of cylinder 104, which may be a circular protrusion extended towards the top end of cylinder 104, shown in FIG. 4 as attachment mechanism 402. In some examples, attachment mechanism 402 may be pressure fit to cylinder 104 via exterior surface 404 of attachment mechanism 402 engaging an interior surface of cylinder 104 that faces exterior surface 404. Exterior surface 404 may include a sealing mechanism such as an O-ring or gasket, etc. to create an air-tight and/or water-tight seal. In other examples, exterior surface 404 may include threads that may engage threads along the interior surface of cylinder 104 that faces exterior surface 404. The diameter of attachment mechanism 402 may be slightly smaller than a diameter of an internal hollow of cylinder 104. Attachment mechanism 402 may be used to hold domed cap 106 to cylinder 104.

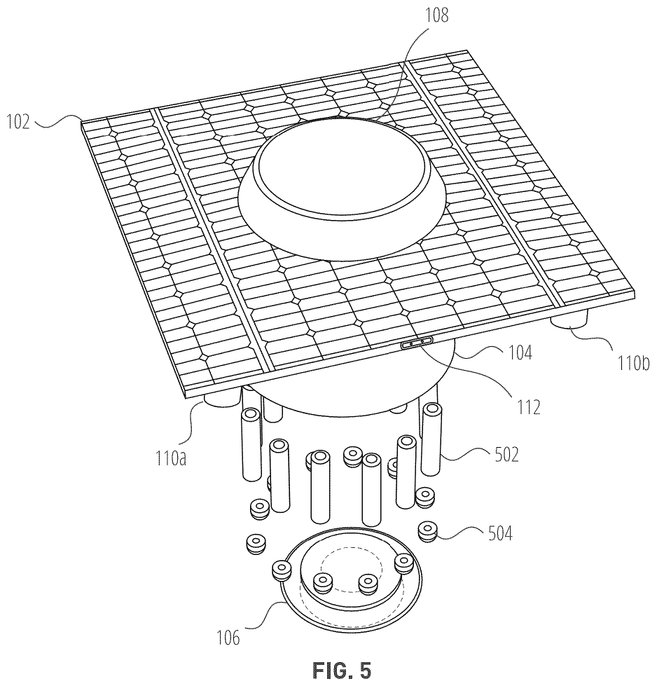

FIG. 5 illustrates a perspective view of an expanded hybrid solar-electric lighting system with power sources and light sources according to some aspects of the present disclosure. Power source 502 and respective light component 504 may be positioned longitudinally within a parallel cavity (such as parallel cavity 302 described in FIG. 3A). There may be one or more instances of power source 502 and respective light component 504. In some examples, the number of instances of power source 502 and respective light component 504 may equal the number of parallel cavities (e.g., each parallel cavity of parallel cavity 302 may be fitted with a power source and a light source). However, in some other examples, the number of instances of power source 502 and respective light component 504 may be less than the number of instances of parallel cavity (e.g., at least one parallel cavity of parallel cavity 302 may be empty).

Power source 502 and light component 504 may be positioned within a respective parallel cavity, such that power source 502 and light component 504 do not protrude from the bottom end of cylinder 104 (e.g., power source 502 and light component 504 do not extend beyond the base at the bottom end of cylinder 104). Power source 502 and light component 504 may be held within the respective parallel cavity by domed cap 106, which may cover the opening of the respective parallel cavity and prevent power source 502 and light component 504 from falling out of the respective parallel cavity. In some examples, domed cap 106 may be removed to access one or more parallel cavities to replace light component and/or power sources.

Power source 502 may include a rechargeable electrical storage cell (e.g., such as, but not limited to, a battery, etc.). In some instances, power source 502 may also include circuitry that modulates electricity provided to the rechargeable electrical storage cell and/or provided to light component 504. The circuitry may include a frequency-based filters, rectifiers, voltage and/or current limiters (e.g., so as to not overload the rechargeable electrical storage cell, etc.), charge and/or discharge cycling algorithms (e.g., trickle charging, fast charge, etc. for efficient charging and life of the rechargeable electrical storage cell, etc.), combinations thereof, and/or the like.

FIG. 6 illustrates a view of the expanded hybrid solar-electric lighting system with power sources and light sources according to some aspects of the present disclosure. In some examples, attachment mechanism 602 may be added to substrate 102, which may provide additional surface area to contact cylinder 104, increasing the strength that cylinder 104 is affixed to substrate 102. For example, a diameter of a surface facing cylinder 104 of attachment mechanism 304 and a diameter of a surface facing attachment mechanism 602 of cylinder 104 may be similar to one another, such that attachment mechanism 602 is directly adjacent to the surface facing attachment mechanism 602 of cylinder 104 and may be in contact or in very close proximity. This may allow for attachment mechanism 602 to include additional adhesive (or another method of affixing cylinder 104 to substrate 102) that may further secure cylinder 104 to substrate 102. In some examples, as shown in FIG. 6, light component 504 and power source 502 may be positioned within parallel cavity 302a.

FIG. 7 illustrates a view of the base of the cylinder of the hybrid solar-electric lighting system according to some aspects of the present disclosure. Cylinder 104 may include parallel cavity 302a, parallel cavity 302b (e.g., as described in FIG. 7), parallel cavity 302c, parallel cavity 302d, parallel cavity 302e, parallel cavity 302f, parallel cavity 302g, parallel cavity 302h, parallel cavity 302i, and parallel cavity 302j (collectively referred to as parallel cavity 302). Parallel cavity 302 should not be construed as limiting. The parallel cavities of parallel cavity 302 may be evenly spaced, or may be spaced according to the lighting requirements of the internal space (e.g., five occurrences of parallel cavity 302 on a first half of cylinder 104 and zero occurrences of parallel cavity 302 on a second half of cylinder 104). In some examples, some or all of the occurrences of parallel cavity 302 may be associated with respective light sources (e.g., light component 504) and respective power sources (e.g., power source 502).

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A hybrid lighting system comprising:
a solar cell; and
a cylinder positioned proximate to the solar cell, wherein the cylinder comprises a first transparent material configured to diffuse natural light to light a facility, wherein the cylinder includes:
a protective cap removably connected to a first end of the cylinder, wherein the protective cap is configured to insulate the cylinder from an external environment, wherein the protective cap comprises a second transparent material configured to allow natural light to pass from the external environment to the cylinder;
a domed cap removably connected to a second end of the cylinder;
one or more power sources electrically coupled to the solar cell; and
one or more light components electrically coupled to the one or more power sources, wherein the one or more light components are configured to provide light to the facility based on a signal.

2. The hybrid lighting system of claim 1, wherein the signal is received from a light sensor.

3. The hybrid lighting system of claim 1, wherein the signal is received from an external switch.

4. The hybrid lighting system of claim 1, wherein the solar cell is configured to recharge the one or more power sources of the one or more light components.

5. The hybrid lighting system of claim 1, wherein the one or more light components are light emitting diodes (LEDs).

6. The hybrid lighting system of claim 1, wherein the cylinder is removably connected to the solar cell through an opening within the solar cell.

7. The hybrid lighting system of claim 1, wherein the cylinder includes a series of parallel cavities distributed along a circumference of the cylinder, wherein the series of parallel cavities house the one or more light components and the one or more power sources.

8. The hybrid lighting system of claim 1, further comprising:
an attachment mechanism attached to the cylinder that extends beyond an opening in the solar cell.

9. The hybrid lighting system of claim 1, wherein the domed cap is removably connected to the cylinder with threads.

10. The hybrid lighting system of claim 1, wherein the protective cap is removably connected to the cylinder with threads.

11. The hybrid lighting system of claim 1, wherein the domed cap is removably connected to the cylinder with adhesive.

12. The hybrid lighting system of claim 1, wherein the protective cap is removably connected to the cylinder with adhesive.

13. The hybrid lighting system of claim 1, wherein the cylinder and the protective cap are a monolithic component.

14. A hybrid lighting system, comprising:
a cylinder, wherein the cylinder comprises a first transparent material configured to diffuse natural light to light a facility, and wherein the cylinder includes one or more light components electrically coupled to one or more power sources, wherein the one or more light components are configured to provide light to the facility based on a signal one or more light component; and
a protective cap removably connected to an end of the cylinder, wherein the protective cap is configured to insulate the cylinder from an external environment, and wherein the protective cap comprises a second transparent material configured to allow natural light to pass from the external environment to the cylinder.

15. The hybrid lighting system of claim 14, wherein the one or more light components are light emitting diodes (LEDs).

16. The hybrid lighting system of claim 14, wherein the cylinder includes a series of parallel cavities distributed along a circumference of the cylinder, wherein the series of parallel cavities house the one or more light components and the one or more power sources.

17. The hybrid lighting system of claim 14, wherein the protective cap is removably connected to the cylinder with threads.

18. The hybrid lighting system of claim 14, wherein the protective cap is removably connected to the cylinder with adhesive.

19. The hybrid lighting system of claim 14, wherein the cylinder and the protective cap are a monolithic component.

20. The hybrid lighting system of claim 14, further comprising:
a domed cap removably connected to a first end of the cylinder, wherein the domed cap is configured to diffuse solar light to provide light to the facility.
